(19) United States
(12) Patent Application Publication
(10) Pub. No.: US 2014/0042863 A1
(43) Pub. Date: Feb. 13, 2014

(54) Brushed Direct Current Motor and Brake System for Vehicle Using The Same

(71) Applicant: Hitachi Automotive Systems, Ltd., Hitachinaka-shi (JP)

(72) Inventors: Masayoshi OJIMA, Hitachi (JP); Kohji MAKI, Hitachinaka (JP)

(21) Appl. No.: 13/940,337

(22) Filed: Jul. 12, 2013

(30) Foreign Application Priority Data
Aug. 10, 2012 (JP) 2012-177682

(51) Int. Cl. H02K 57/00

(52) U.S. Cl. CPC H02K 57/006
USPC 310/195

(57) ABSTRACT

In a brushed direct current motor including a stator that is provided with 2×P magnetic poles (P is odd and greater than or equal to three), an armature core rotatably held with respect to the stator and includes P×N±2 teeth (N is an even and greater than or equal to four) in a circumferential direction, a commutator held so as to integrally rotate with the armature core and includes commutator segments, the number of the commutator segments being the same as that of the teeth, a winding wound around the teeth in a double-wave form, and two anode brushes and two cathode brushes arranged in sliding contact with the commutator, a width angle WB of each of the brushes in sliding contact with the commutator is set so as to satisfy a relation of “WB>WP+WI”.

### BACKGROUND OF THE INVENTION

1. Field of the Invention

The present invention relates to a brushed direct current motor.

2. Description of the Related Art

As a brushed direct current (DC) motor used in auxiliary equipment for a vehicle, there is known one including six magnetic poles, an even number of teeth, and a winding wound around the teeth in a wave form. FIG. 8 illustrates a cross-sectional view (XZ plane) of the brushed DC motor as above. The brushed DC motor includes a housing 100, magnets 102 which are fixed inside the housing 100, a shaft 110 which is rotatably supported using bearings 107 inside the housing 100, a core 112 which integrally rotates with the shaft 110, a commutator 111 with a winding 113, and brushes 104 which are slidably pressed against the commutator 111. Further, a front plate 101 which is fixed to the housing 100 includes one of the bearings 107 for rotatably supporting the shaft 110 and a brush holder 103 for holding the brushes 104.

Such a brushed DC motor including an even number of teeth produces smaller vibration, but causes larger torque pulsation than a brushed DC motor including an odd number of teeth. Therefore, it is necessary to reduce the torque pulsation. In view of this, JP-2010-273532-A discloses a brushed DC motor including six magnetic poles, an even number of teeth, and a winding which is wound around the teeth in a double-wave form in which the number of brushes is six although it is normally two.

FIG. 9 illustrates an XY cross sectional view of a DC motor which is provided with six brushes as with JP-2010-273532-A when viewed from a rotational axis direction of a shaft 110. Six magnets 102 are arranged in an inner circumferential part of a housing 100 at equal intervals to thereby form six magnetic poles. A commutator 111 includes an insulator 111b and twenty commutator segments 111a which are periodically arranged on an outer circumference of the insulator 111b. Further, six brushes 104 are arranged so as to slidingly contact with the commutator segments 111a from outer circumferences thereof. The six brushes 104 are composed of three anode brushes 105 and three cathode brushes 106 which are alternately arranged at equal intervals in a rotational direction. A core 112 includes twenty teeth 112a which radially extend from the shaft 110 and are periodically arranged in a circumferential direction of the core 112 and a core back 112b to which the teeth 112a are connected. A slot 114 is formed between each adjacent two of the teeth 112a that are adjacent to each other in the circumferential direction, and a winding 113 is inserted into the slot 114. The winding 113 includes a plurality of coils 113a each of which is wound across a plurality of the teeth 112a. However, FIG. 9 illustrates only one of the coils 113a.

FIG. 10 illustrates a planarly developed schematic view of the brushed DC motor shown in FIG. 9 including the teeth 112a, the slots 114, the winding 113, the commutator segments 111a, and the brushes 104. Each of the coils 113a has a lead wire which is wound across plural ones of the teeth 112a and both ends of which are connected to different ones of the commutator segments 111a. For example, one of the coils 113a that has a lead wire one end of which is connected to a second one of the commutator segments 111a is wound around the teeth 112a of T4 to T6, and the other end of the lead wire is connected to an eighth one of the commutator segments 111a. Further, another one of the coils 113a that has a lead wire one end of which is connected to the eighth one of the commutator segments 111a is then wound around the teeth 112a of T10 to T12, and the other end of the lead wire is connected to a fourteenth one of the commutator segments 111a. By repeating this, the coils 113a are connected to even-numbered ones of the commutator segments 111a. Thereafter, another one of the coils 113a is wound in the same manner as in the above so that one end of a lead wire thereof is connected to a next one of the commutator segments 111a to that in the above. As a result, the coils 113a are connected to odd-numbered ones of the commutator segments 111a. In this manner, the coils 113a are wound around all of the teeth 112a, and such a wire connection state is called “double-wave winding”.

Generally, in a brushed DC motor, electric current flowing from an anode brush to a cathode brush generates torque. On the other hand, a coil forming a closed circuit between brushes of the same pole becomes an ineffective coil which does not contribute to torque. Therefore, the number of ineffective coils changes along with the rotation of the core 112, which causes torque pulsation. In FIG. 10, the coils 113a indicated by thick lines are ineffective coils, and the total number of ineffective coils between the anode brushes is two. It is described in JP-2010-273532-A that the number of ineffective coils between the anode brushes periodically changes along with the rotation of the core 112 to two, one, two, and one in this order, and the range of the change is one and therefore small, which results in low torque pulsation.

### SUMMARY OF THE INVENTION

When the number of brushes is set to six in order to reduce torque pulsation in a brushed DC motor which is provided with six magnetic poles, an even number of teeth, and a winding wound in a wave form in the same manner as in JP-2010-273532-A, anode brushes and cathode brushes are alternately arranged in the circumferential direction. As a result, the power wiring becomes complicated. On the other hand, when the number of brushes is reduced from six to four, as shown in FIG. 11, torque pulsation is increased compared to a case where a brushed DC motor includes six brushes.

In view of this, the present invention provides a brushed DC motor that is capable of reducing toque pulsation even when the brushed DC motor includes four brushes.

In order to solve the above problem, the configurations described in claims are employed, for example. The present application includes a plurality of means for solving the above problem, and the following is an example thereof. In a brushed direct current motor including a stator which is provided with 2×P magnetic poles (P is an odd number equal to or more than three), an armature core which is rotatably held with respect to the stator and includes P×N±2 teeth (N is an even number equal to or more than four) in a circumferential direction thereof, a commutator which is held so as to integrally rotate with the armature core and includes commutator segments, the number of the commutator segments being the same as that of the teeth, a winding which is wound around the teeth in a double-wave form, and two anode brushes and two cathode brushes arranged in sliding contact with the commutator, a width angle WB of each of the brushes in sliding contact with the commutator is set so as to satisfy a relation of “WB>WP+WI”, where WP denotes a width angle of a pitch of the commutators and WI denotes a width angle of an interval between the commutators.

In the present invention, even when the brushed DC motor includes four brushes, the rate of change of the number of ineffective coils (the rate of change of the number of ineffective coils is (“the maximum number of ineffective coils”−“the minimum number of ineffective coils”)/“the minimum number of ineffective coils”) becomes one or less by setting the width angle of each of the brushes to be larger than a certain width angle. As a result, it is possible to reduce torque pulsation.

Other objects, configurations and effects of the present invention will become apparent from the following description of embodiments.

### BRIEF DESCRIPTION OF THE DRAWINGS

FIG. 1 is a planarly developed schematic view of a brushed DC motor of a first embodiment;

FIGS. 2A to 2D illustrate a relationship between the number of ineffective coils and time change when a width angle of a brush is set to 24° in the brushed DC motor of the first embodiment;

FIG. 3 illustrates a relationship between a rate of change of the number of ineffective coils and the width angle of the brush in the first embodiment;

FIGS. 4A to 4D illustrate a relationship between the number of ineffective coils and time change when a width angle of a brush is set to 16° in a brushed DC motor of a second embodiment;

FIG. 5 illustrates a relationship between a rate of change of the number of ineffective coils and the width angle of the brush in the second embodiment;

FIG. 6 illustrates an example of a combination of the number of poles and the number of teeth by which an effect that is equivalent to that in the first embodiment or the second embodiment can be achieved;

FIG. 7 is a schematic view of a brake system for a vehicle using the brushed DC motor of the present invention;

FIG. 8 is an XZ cross-sectional view of a brushed DC motor;

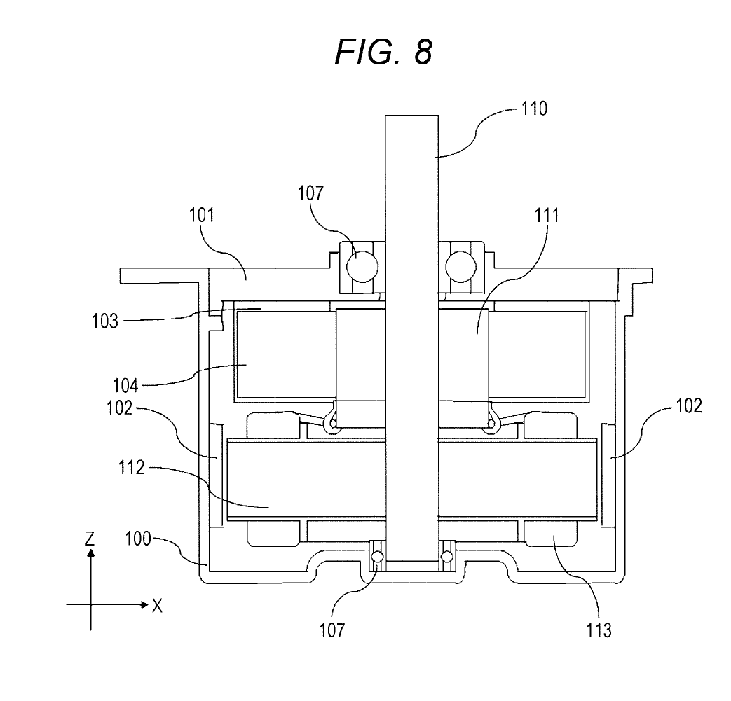

FIG. 9 is a cross-sectional view (XY plane) in an axial direction of a brushed DC motor including six brushes;

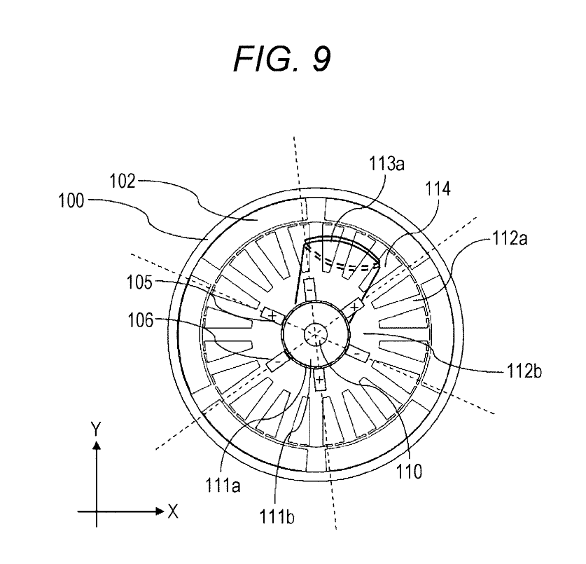

FIG. 10 is a planarly developed schematic view of a conventional brushed DC motor; and

FIG. 11 is a cross-sectional view (XY plane) in an axial direction of a brushed DC motor including four brushes.

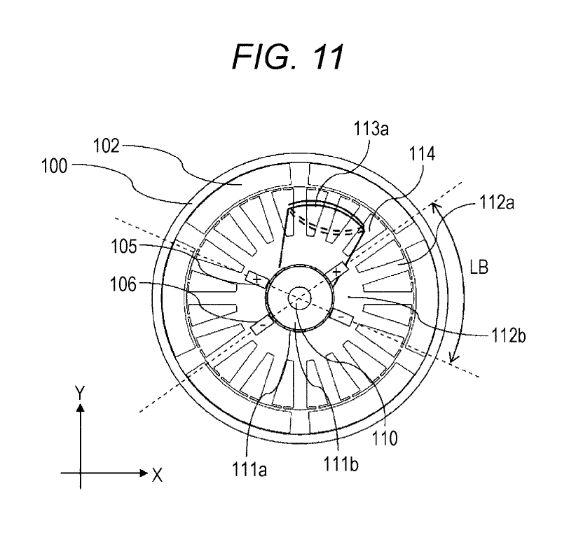

### DESCRIPTION OF THE PREFERRED EMBODIMENTS

### First Embodiment

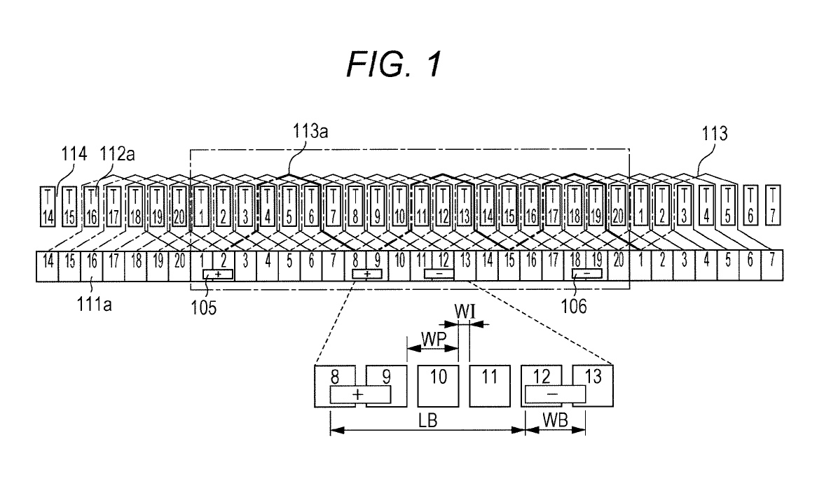

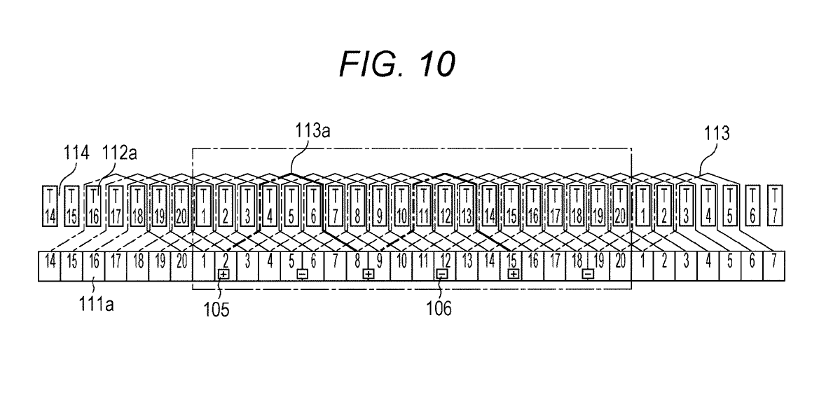

FIG. 1 illustrates a planarly developed schematic view of a brushed direct current (DC) motor of a first embodiment of the present invention including teeth 112a, slots 114, a winding 113, commutator segments 111a, and brushes 104. The number of magnetic poles (not shown) is set to “2×P” (P is an odd number equal to or more than three). Further, the number of the teeth 112a should be “P×N±2” (N is an even number equal to or more than four). In the present embodiment, the number of the magnetic poles is set to six, and the number of the teeth 112a is set to 20 by P=3 and N=6. Each of coils 113a is wound in a double-wave form in the same manner as shown in FIG. 10. In the brushed DC motor configured in such a manner, a width angle WB in the circumferential direction of each of the four brushes 104 which slidingly contacts with the commutator segments 111a is set so as to satisfy the relation of “WB>WP+WI”, where WP denotes a width angle in the circumferential direction of a pitch along which the commutator segments 111a are arranged, and WI denotes a width angle in the circumferential direction of an interval between adjacent ones of the commutator segments 111a.

The above-described WB, WP, WI, and LB which is a width angle in the circumferential direction of an interval between the same ends of adjacent brushes of different poles are illustrated in FIG. 1 in a partially elongated manner. In the present embodiment, WP=18°, WI=2°, and LB=60°. Therefore, when the width angle of each of the brushes is set to 24°, for example, the above relational expression regarding the brush width angle WB is satisfied.

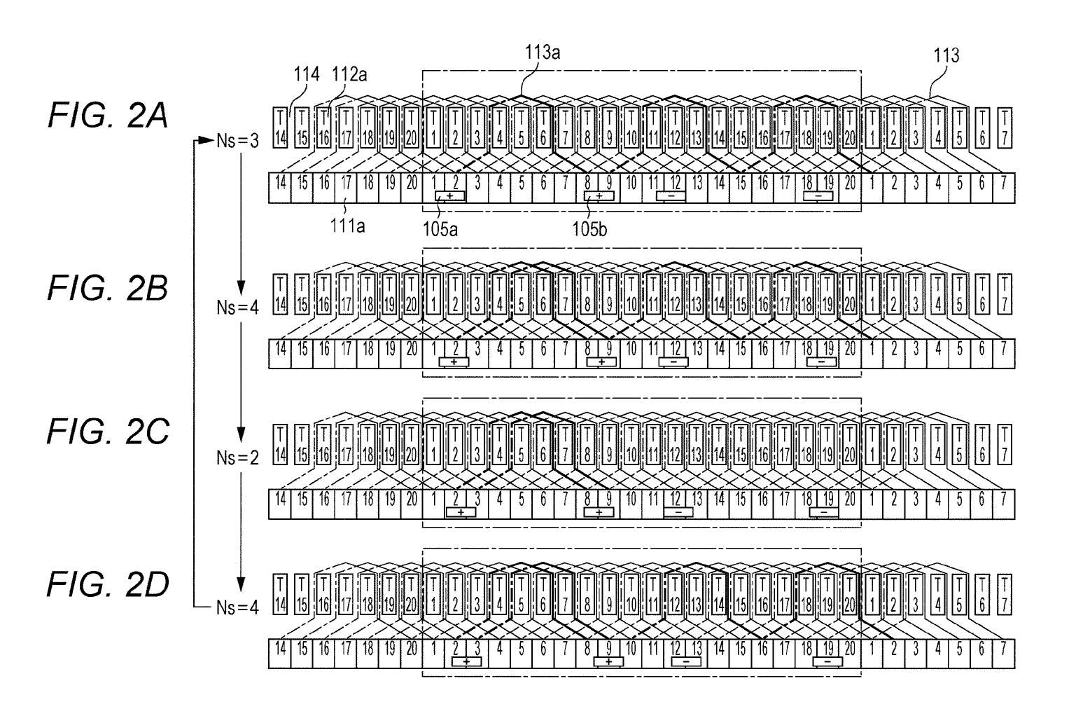

FIGS. 2A to 2D illustrate details of change with time of the number Ns of ineffective ones of the coils 113a between anode brushes in the present embodiment. The rotation of the core 112 is simulated by moving the positions of the brushes 104. As shown in FIG. 2A, when one of anode brushes 105, namely, an anode brush 105b is positioned in substantially the center in the circumferential direction between adjacent ones of the commutator segments 111a, the other of the anode brushes 105, namely, an anode brush 105a is also in sliding contact with two of the commutator segments 111a. The number of commutator segments 111a that are not in contact with any of the anode brushes 105 between the anode brushes 105 is five. In this case, the coils 113a indicated by thick lines in FIG. 2A are ineffective coils, and the total number of ineffective coils is therefore three. Next, as shown in FIG. 2B, when the core 112 slightly rotates, and the anode brush 105a thereby slidingly contacts with three of the commutator segments 111a, the total number of ineffective coils becomes four. Then, when the core 112 further rotates slightly, two of the anode brushes 105 make contact with two of the commutator segments 111a as shown in FIG. 2C. As a result, the number of commutator segments 111a that are not in contact with any of the anode brushes 105 between the anode brushes 105 becomes four. In this case, the total number of ineffective coils becomes two. Then, when the core 112 further rotates slightly, and the anode brush 105b thereby slidingly contacts with three of the commutator segments 111a as shown in FIG. 2D, the total number of ineffective coils becomes four. Then, when the core 112 further rotates slightly, a state becomes the same as that shown in FIG. 2A. That is, the core 112 has rotated by the pitch WP of the commutator segments. Thereafter, these processes are repeated. In this manner, the number of ineffective coils between the anode brushes 105 repeatedly becomes three, four, two, and four in this order while the core 112 is rotating.

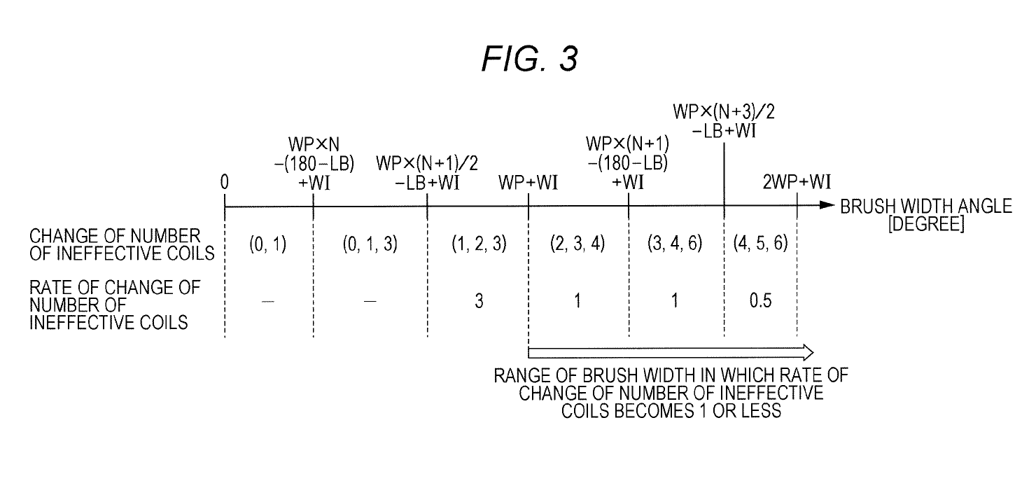

In FIG. 3, there is listed dependency of change with time of the number of ineffective coils between anode brushes on the brush width in a brushed DC motor which includes 2×P magnetic poles, P×N±1 teeth, four brushes, and a winding which is wound in a double-wave form in the same manner as in the first embodiment of the present invention. In this case, torque pulsation when the brush width is changed depends on the rate of change of the number of ineffective coils ((“the maximum number of ineffective coils”−“the minimum number of ineffective coils”)/“the minimum number of ineffective coils”).

As described in “Description of the Related Art”, the rate of change of the number of ineffective coils in a conventional brushed DC motor which includes six brushes is “(2−1)/1=1”. When the number of brushes is four, the rate of change of the number of ineffective coils becomes one or less by setting the width angle of each of the brushes to be larger than “WP+WI”. Accordingly, it is possible to achieve low torque pulsation that is equivalent to that in a brushed DC motor including six brushes. Further, since the number of brushes is four, power wiring becomes easy, thereby making it possible to also reduce cost.

### Second Embodiment

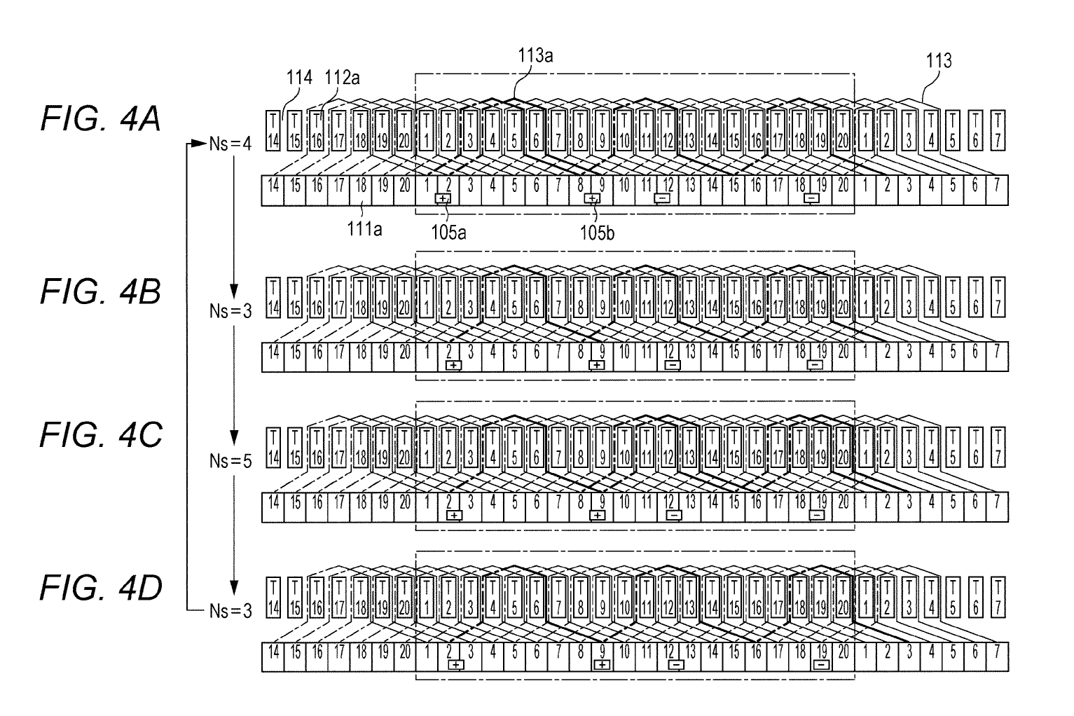

FIGS. 4A to 4D are planarly developed schematic views of a brushed DC motor of a second embodiment of the present invention including teeth 112a, slots 114, a winding 113, commutator segments 111a, and brushes 104. The number of magnetic poles (not shown) is set to “2×P”. Further, the number of the teeth 112a should be “P×N−1”. In the present embodiment, the number of the magnetic poles is set to six, and the number of the teeth 112a is set to 20 by P=3 and N=7. A coil 113a that has a lead wire one end of which is connected to a second one of the commutator segments 111a is wound around the teeth 112a of T4 to T6, and the other end of the lead wire is connected to a ninth one of the commutator segments 111a. Further, another coil 113a that has a lead wire one end of which is connected to the ninth one of the commutator segments 111a is then wound around the teeth 112a of T11 to T13, and the other end of the lead wire is connected to a sixteenth one of the commutator segments 111a. By repeating this, a plurality of coils 113a is continuously wound around all of the teeth 112a. Such a wire connection state is called “single wave-winding”. In the brushed DC motor configured in such a manner, a width angle WB in the circumferential direction of each of the four brushes 104 which slidingly contacts with the commutator segments 111a is set so as to satisfy the relation of “WB>WP×(N+1)/2+WI−LB”. In the present embodiment, WP=18°, WI=2°, and LB=60°. Therefore, when the width angle of each of the brushes is set to, for example, 16°, the above relational expression regarding the brush width angle WB is satisfied.

Next, details of change with time of the number Ns of ineffective ones of the coils 113a between anode brushes in the present embodiment will be described with reference to FIGS. 4A to 4D. As shown in FIG. 4A, when one of anode brushes 105, namely, an anode brush 105b is positioned in substantially the center in the circumferential direction between adjacent ones of the commutator segments 111a, the other of the anode brushes 105, namely, an anode brush 105a is in sliding contact with two of the commutator segments 111a. The number of commutator segments 111a that are not in contact with any of the anode brushes 105 between the anode brushes 105 is five. In this case, the coils 113a indicated by thick lines in FIG. 4A are ineffective coils, and the total number of ineffective coils is therefore four. Next, as shown in FIG. 4B, when the core 112 slightly rotates, and the anode brush 105a thereby slidingly contacts with one of the commutator segments 111a, the total number of ineffective coils becomes three. Then, when the core 112 further rotates slightly, two of the anode brushes 105 make contact with two of the commutator segments 111a as shown FIG. 4C. As a result, the number of commutator segments 111a that are not in contact with any of the anode brushes 105 between the anode brushes 105 becomes four. In this case, the total number of ineffective coils becomes five. Then, when the core 112 further rotates slightly, and the anode brush 105b thereby slidingly contacts with one of the commutator segments 111a as shown in FIG. 4D, the total number of ineffective coils becomes three. Then, when the core 112 further rotates slightly, a state becomes the same as that shown in FIG. 4A. That is, the core 112 has rotated by the pitch WP of the commutator segments. Thereafter, these processes are repeated. In this manner, the number of ineffective coils repeatedly becomes four, three, five, and three in this order while the core 112 is rotating.

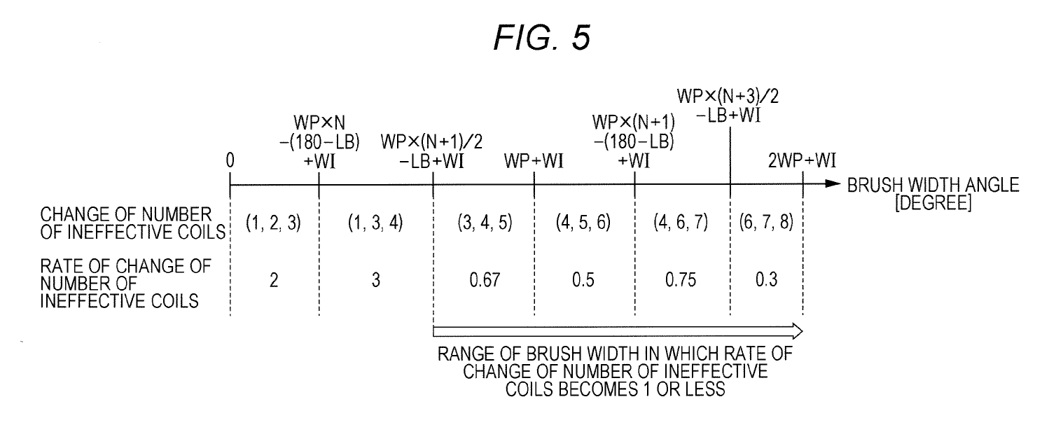

In FIG. 5, there is listed dependency of change with time of the number of ineffective coils between anode brushes on the brush width in a brushed DC motor which includes 2×P magnetic poles, P×N−1 teeth, four brushes, and a winding which is wound in a single-wave form in the same manner as in the second embodiment of the present invention. When the winding is wound in a single-wave form, it is possible to allow the rate of change of the number of ineffective coils to become one or less by setting the width angle of each of the brushes to be larger than “WP×(N+1)/2−LB+WI”. Accordingly, it is possible to achieve low torque pulsation that is equivalent to that in a brushed DC motor including six brushes.

Further, when the number of magnetic poles is “2×P”, the number of teeth is “P×N+1”, and a winding is wound in a single-wave form, the same effect as above can be achieved by setting the width angle of each of the brushes to be larger than “WP×(N+1)−(180−LB)+WI”.

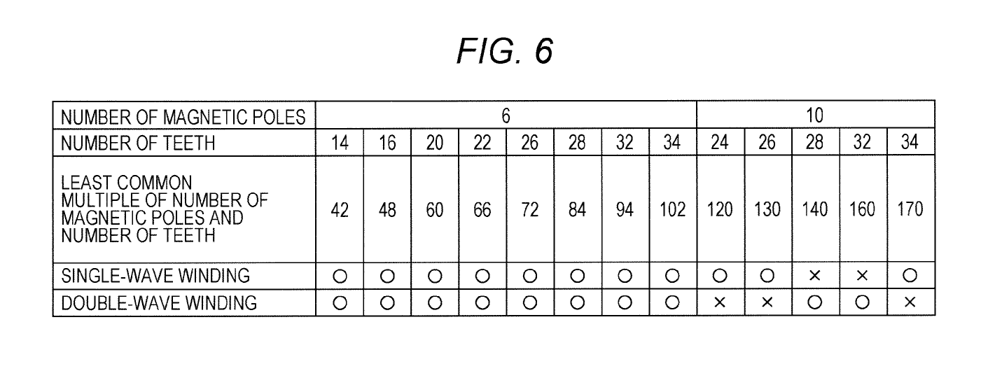

FIG. 6 illustrates an example of a combination of the number of magnetic poles, the number of teeth, and a wire connection state by which an effect that is equivalent to that in the present embodiment can be achieved. In a combination of six magnetic poles with twenty teeth, the least common multiple of the number of magnetic poles and the number of teeth becomes 60. In this case, cogging torque pulsation becomes smaller than that in a current product in which, for example, the number of magnetic poles is four and the number of teeth is 13 (the least common multiple of the number of magnetic poles and the number of teeth is 52). When the number of teeth is 16 or less, the width angle of each of the brushes can be made wider than that in a case where the number of teeth is 20. As a result, the current density in each of the brushes is reduced, thereby making it possible to suppress temperature rise in the brushes. Further, when the number of teeth is 22 or more, the cogging torque pulsation can be made further smaller than that in a case where the number of teeth is 20.

### Third Embodiment

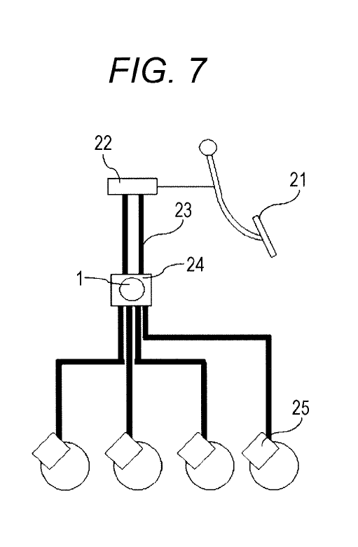

An embodiment of a brake system for a vehicle using the brushed DC motor of the present invention will be described with reference to FIG. 7. Force input to a brake pedal 21 which is attached to a four-wheeled vehicle is converted into hydraulic pressure by a master cylinder 22. In this regard, the force input to the brake pedal 21 may be transmitted to the master cylinder 22 through a shaft or the like, or may also be converted into an electrical signal and then transmitted to the master cylinder 22. The hydraulic pressure which is directly generated by the master cylinder 22 is transferred to a hydraulic control unit 24 through hydraulic pipes 23. The hydraulic control unit 24 is provided with a brushed DC motor, a pump unit, and an electronic control unit. The hydraulic pressure is divided in the hydraulic control unit 24 and then transmitted to wheel braking systems 25 which are attached to respective four wheels, thereby generating braking force of the vehicle. At this time, the hydraulic pressure is increased or reduced by the hydraulic control unit 24 according to the behavior of the vehicle to thereby stabilize the attitude of the vehicle. By using the brushed DC motor of the present invention in the hydraulic control unit 24, it becomes possible to reduce change with time of the hydraulic pressure discharged from the hydraulic control unit 24.

The present invention is not limited to the above embodiments, and includes various modifications. For example, the embodiments set forth above have been described in detail for the purpose of easy understanding of the present invention, and the present invention is therefore not necessarily limited to one including all of the described constituent elements. Further, it is possible to replace a part of the constituent elements of a certain embodiment by that of other embodiment, or also to add the constituent element(s) of the other embodiment to the constituent elements of the certain embodiment. Further, with respect to a part of the constituent elements of each of the embodiments, it is also possible to make addition/deletion/substitution of other constituent element(s).

1. A brushed direct current motor comprising:
a stator provided with 2×P magnetic poles, where P is an odd number equal to or more than three;
an armature core rotatably held with respect to the stator, the armature core including P×N±2 teeth in a circumferential direction thereof, where N is an even number equal to or more than four;
a commutator held so as to integrally rotate with the armature core, the commutator including commutator segments, the number of the commutator segments being the same as the number of the teeth;
a winding wound around the teeth in a double-wave form; and
two anode brushes and two cathode brushes arranged in sliding contact with the commutator,
wherein a width angle WB of each of the brushes in sliding contact with the commutator is set so as to satisfy a relation of WB>WP+WI, where WP denotes a width angle of a pitch of the commutators, and WI denotes a width angle of an interval between the commutators.

2. A brushed direct current motor comprising:
a stator provided with 2×P magnetic poles, where P is an odd number equal to or more than three;
an armature core rotatably held with respect to the stator, the armature core including P×N−1 teeth in a circumferential direction thereof, where N is an odd number equal to or more than five;
a commutator held so as to integrally rotate with the armature core, the commutator including commutator segments, the number of the commutator segments being the same as the number of the teeth;
a winding wound around the teeth in a single-wave form; and
two anode brushes and two cathode brushes arranged in sliding contact with the commutator,
wherein a width angle WB of each of the brushes in sliding contact with the commutator is set so as to satisfy a relation of WB>WP×(N+1)/2−LB+WI, where WP denotes a width angle of a pitch of the commutators, WI denotes a width angle of an interval between the commutators, and LB denotes a width angle of an interval between the same ends of adjacent brushes of different poles.

3. A brushed direct current motor comprising:
a stator provided with 2×P magnetic poles, where P is an odd number equal to or more than three;
an armature core rotatably held with respect to the stator, the armature core including P×N+1 teeth in a circumferential direction thereof, where N is an odd number equal to or more than five;
a commutator held so as to integrally rotate with the armature core, the commutator including commutator segments, the number of the commutator segments being the same as the number of the teeth;
a winding wound around the teeth in a single-wave form; and
two anode brushes and two cathode brushes arranged in sliding contact with the commutator,
wherein a width angle WB of each of the brushes in sliding contact with the commutator is set so as to satisfy a relation of WB>WP×(N+1)−(180−LB+WI), where WP denotes a width angle of a pitch of the commutators, WI denotes a width angle of an interval between the commutators, and LB denotes a width angle of an interval between the same ends of adjacent brushes of different poles.

4. The brushed direct current motor according to claim 1, wherein the number of the magnetic poles is six.

5. The brushed direct current motor according to claim 4, wherein the number of the teeth is 20.

6. The brushed direct current motor according to claim 4, wherein the number of the teeth is 16 or less.

7. The brushed direct current motor according to claim 4, wherein the number of the teeth is 22 or more.

8. A brake system for a vehicle including the brushed direct current motor according to claim 1.

9. The brushed direct current motor according to claim 2, wherein the number of the magnetic poles is six.

10. The brushed direct current motor according to claim 3, wherein the number of the magnetic poles is six.

11. A brake system for a vehicle including the brushed direct current motor according to claim 2.

12. A brake system for a vehicle including the brushed direct current motor according to claim 3.

13. A brake system for a vehicle including the brushed direct current motor according to claim 4.

14. A brake system for a vehicle including the brushed direct current motor according to claim 5.

15. A brake system for a vehicle including the brushed direct current motor according to claim 6.

16. A brake system for a vehicle including the brushed direct current motor according to claim 7.
